(19) United States
(12) Patent Application Publication
(10) Pub. No.: US 2011/0207879 A1
(43) Pub. Date: Aug. 25, 2011

(54) CONJUGATED DIENE POLYMER, CONJUGATED DIENE POLYMER COMPOSITION, AND METHOD FOR PRODUCING CONJUGATED DIENE POLYMER

(75) Inventors: Mana ITO, Tokyo (JP); Mayumi OSHIMA, Kanagawa (JP); Katsunari INAGAKI, Chiba (JP)

(73) Assignee: SUMITOMO CHEMICAL COMPANY, LIMITED, Tokyo (JP)

(21) Appl. No.: 13/033,359

(22) Filed: Feb. 23, 2011

(30) Foreign Application Priority Data
Feb. 25, 2010 (JP) 2010-039998
May 6, 2010 (JP) 2010-106182

(51) Int. Cl. C08L 9/06; C08F 8/42

(52) U.S. Cl. 524/572; 525/105

(57) ABSTRACT

A conjugated diene polymer is provided that includes a conjugated diene-based monomer unit and a monomer unit based on a monomer represented by Formula (1) below, the polymer having at least one terminus modified by a compound represented by Formula (2) below

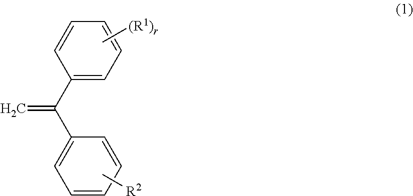

wherein r is 0 or 1, R¹ denotes a hydrocarbyl group having 1 to 10 carbon atoms or a group containing at least one atom selected from the atomic group consisting of a nitrogen atom, an oxygen atom, and a sulfur atom, and R² denotes a group containing at least one atom selected from the atomic group consisting of a nitrogen atom, an oxygen atom, and a sulfur atom

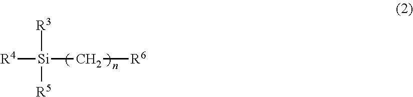

wherein n denotes an integer of 1 to 10, R³, R⁴, and R⁵ independently denote a hydrocarbyl group having 1 to 10 carbon atoms or a hydrocarbyloxy group having 1 to 10 carbon atoms, at least one of R³, R⁴, and R⁵ is a hydrocarbyloxy group, and R⁶ denotes a group containing at least one atom selected from the atomic group consisting of a nitrogen atom, an oxygen atom, and a sulfur atom.

### FIELD OF THE INVENTION

The present invention relates to a conjugated diene polymer, a conjugated diene polymer composition, and a method for producing a conjugated diene polymer.

### BACKGROUND OF THE INVENTION

In recent years, with the growing concern over environmental problems the demand for good fuel economy for automobiles has been becoming stronger, and there is also a demand for excellent fuel economy for polymer compositions used for automobile tires. As a polymer composition for automobile tires, a polymer composition comprising a conjugated diene polymer such as polybutadiene or a butadiene-styrene copolymer and a reinforcing agent such as carbon black or silica, etc. is used.

For example, as a conjugated diene polymer, polymer composition employing a conjugated diene polymer formed by modifying with a dialkylamino group-containing alkoxylsilane one terminus of a polymer formed by copolymerizing butadiene and styrene using an alkyllithium as a polymerization initiator (see e.g. JP•A•63-186748 (JP-A denotes a Japanese unexamined patent application publication)), as a conjugated diene polymer, a polymer composition employing a conjugated diene polymer formed by modifying with a dialkylamino group-containing 1,1-diphenylethylene one terminus of a polymer formed by copolymerizing butadiene and styrene using an alkyllithium as a polymerization initiator (see e.g. JP•A•2003-160603), etc. have been proposed as polymer compositions having good fuel economy.

### SUMMARY OF THE INVENTION

However, the above-mentioned conventional polymer compositions employing a conjugated diene polymer are not always satisfactory in terms of abrasion resistance.

Under such circumstances, an object of the present invention is to provide a conjugated diene polymer that can give a conjugated diene polymer composition having excellent abrasion resistance, a conjugated diene polymer composition containing the conjugated diene polymer and a reinforcing agent such as silica, and a method for producing the conjugated diene polymer.

A first aspect of the present invention relates to a conjugated diene polymer comprising a conjugated diene-based monomer unit and a monomer unit based on a compound represented by Formula (1) below, and the polymer having at least one terminus modified by a compound represented by Formula (2) below.

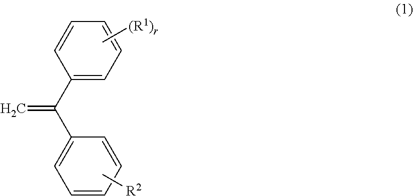

wherein r is 0 or 1, R¹ denotes a hydrocarbyl group containing 1 to 10 carbon atoms or a group containing at least one atom selected from the atomic group consisting of a nitrogen atom, an oxygen atom, and a sulfur atom, and R² denotes a group containing at least one atom selected from the atomic group consisting of a nitrogen atom, an oxygen atom, and a sulfur atom.

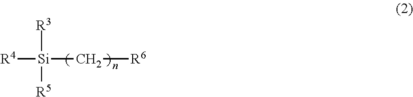

wherein n denotes an integer of 1 to 10, R³, R⁴, and R⁵ independently denote a hydrocarbyl group having 1 to 10 carbon atoms or a hydrocarbyloxy group having 1 to 10 carbon atoms, at least one of R³, R⁴, and R⁵ is a hydrocarbyloxy group, and R⁶ denotes a group containing at least one atom selected from the atomic group consisting of a nitrogen atom, an oxygen atom, and a sulfur atom.

A second aspect of the present invention relates to a conjugated diene polymer composition comprising the above described conjugated diene polymer and a reinforcing agent.

A third aspect of the present invention relates to a method for producing a conjugated diene polymer, comprising the steps of

(A) polymerizing monomer components comprising a conjugated diene and a compound represented by Formula (1) below in a hydrocarbon solvent using an alkali metal catalyst, the polymer having an alkali metal catalyst-derived alkali metal in at least one terminus of a polymer chain, and
(B) reacting the polymer obtained in step A and a compound represented by Formula (2) below

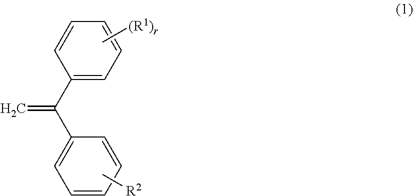

wherein r is 0 or 1, R¹ denotes a hydrocarbyl group having 1 to 10 carbon atoms or containing at least one atom selected from the atomic group consisting of a nitrogen atom, an oxygen atom, and a sulfur atom, and R² denotes a group containing at least one atom selected from the atomic group consisting of a nitrogen atom, an oxygen atom, and a sulfur atom

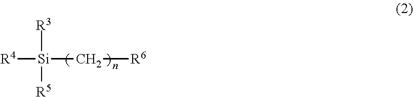

wherein n denotes an integer of 1 to 10, R³, R⁴, and R⁵ independently denote a hydrocarbyl group having 1 to 10 carbon atoms or a hydrocarbyloxy group having 1 to 10 carbon atoms, at least one of R³, R⁴, and R⁵ is a hydrocarbyloxy group, and R⁶ denotes a group containing at least one atom selected from the atomic group consisting of a nitrogen atom, an oxygen atom, and a sulfur atom. A mixture of two or more compounds represented by Formula (2) may be used.

In accordance with the present invention, there can be provided a conjugated diene polymer that can give a conjugated diene polymer composition having excellent abrasion resistance, a polymer composition formed by combining the conjugated diene polymer and a reinforcing agent such as silica, and a method for producing the conjugated diene polymer.

### MODE FOR CARRYING OUT THE INVENTION

The conjugated diene polymer of the present invention is a conjugated diene polymer containing a conjugated diene-based monomer unit and a monomer unit based on a monomer represented by Formula (1) above, the polymer having at least one terminus modified by a compound represented by Formula (2) above.

Examples of the conjugated diene include 1,3-butadiene, isoprene, 1,3-pentadiene, 2,3-dimethyl-1,3-butadiene, and 1,3-hexadiene, and one or more types thereof may be used. The conjugated diene is preferably 1,3-butadiene or isoprene.

In Formula (1), r is 0 or 1.

In Formula (1), R¹ and R² are substituents on the benzene rings, and the substitution position may be any of the 2-position, 3-position, 4-position, 5-position, and 6-position; it is preferably the 3-position, 4-position, or 5-position, and more preferably the 4-position.

With regard to the substitution position of R¹, the position of the benzene ring to which the following group is bonded is defined as the 1-position. The position of bonding is denoted by * in the formula below.

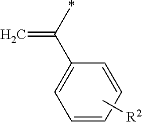

With regard to the substitution position of R², the position of the benzene ring to which the following group is bonded is defined as the 1-position. The position of bonding is denoted by * in the formula below.

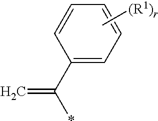

In Formula (1), R¹ denotes a hydrocarbyl group or a group containing at least one atom selected from the atomic group consisting of a nitrogen atom, an oxygen atom, and a sulfur atom, and R² denotes a group containing at least one atom selected from the atomic group consisting of a nitrogen atom, an oxygen atom, and a sulfur atom. R² is preferably an aliphatic or cyclic group having 0 to 6 carbon atoms in which a nitrogen atom, oxygen atom, or sulfur atom is directly bonded to the phenyl group.

In the present specification, a hydrocarbyl group denotes a hydrocarbon residue, and a hydrocarbyloxy group denotes a group in which the hydrogen atom of a hydroxyl group is replaced with a hydrocarbyl group.

With regard to the group, denoted by R¹ and R², containing at least one atom selected from the atomic group consisting of a nitrogen atom, an oxygen atom, and a sulfur atom, examples of the nitrogen atom-containing group include an amino group, a dimethylamino group, a diethylamino group, an isocyano group, a 1-aziridinyl group, a 1-pyrrolidinyl group, a 1-piperidinyl group, a hexamethyleneimino group, a 1-imidazolyl group, a 4,5-dihydro-1-imidazolyl group, a 1-imidazolidinyl group, a 1-piperazinyl group, and a morpholino group. Further examples include a cyano group, a 2-pyrrolidyl group, a 2-piperidinyl group, a 2-pyridyl group, a 3-pyridyl group, a 4-pyridyl group, and a 2-pyrazinyl group.

With regard to the group, denoted by R¹ and R², containing at least one atom selected from the atomic group consisting of a nitrogen atom, an oxygen atom, and a sulfur atom, examples of the oxygen atom-containing group include a hydrocarbyloxy group such as an alkoxy group, an aryloxy group, or an aralkyloxy group; a substituted hydrocarbyl group containing a hydrocarbyloxy group as a substituent such as an alkoxyalkyl group or an alkoxyaryl group; a heterocyclic group containing an oxygen atom as a ring-constituting heteroatom; a trihydrocarbylsilyloxy group such as a trialkylsilyloxy group; and a trihydrocarbyloxysilyl group such as a trialkoxysilyl group.

Examples of the alkoxy group include a methoxy group, an ethoxy group, an n-propoxy group, an isopropoxy group, an n-butoxy group, a sec-butoxy group, and a t-butoxy group.

Examples of the aryloxy group include a phenoxy group. Examples of the aralkyloxy group include a benzyloxy group. Examples of the alkoxyalkyl group include a methoxymethyl group, a methoxyethyl group, an ethoxymethyl group, and an ethoxyethyl group. Examples of the alkoxyaryl group include a methoxyphenyl group and an ethoxyphenyl group. Examples of the heterocyclic group containing an oxygen atom as a ring-constituting heteroatom include an oxiranyl group, a tetrahydrofuranyl group, and a dioxolanyl group. Examples of the trialkylsilyloxy group include a trimethylsilyloxy group, a triethylsilyloxy group, a triisopropylsilyloxy group, and a t-butyldimethylsilyloxy group. Examples of the trialkoxysilyl group include a trimethoxysilyl group, a triethoxysilyl group, and a tri-n-propoxysilyl group.

With regard to the group, denoted by R¹ and R², containing at least one atom selected from the atomic group consisting of a nitrogen atom, an oxygen atom, and a sulfur atom, examples of the sulfur atom-containing group include a mercapto group.

The group containing at least one atom selected from the atomic group consisting of a nitrogen atom, an oxygen atom, and a sulfur atom is preferably a nitrogen atom-containing group, and more preferably a group represented by Formula (3) below

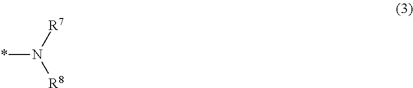

wherein, R⁷ and R⁸ independently denote a hydrocarbyl group or a trihydrocarbylsilyl group, or R⁷ and R⁸ are bonded to each other and denote a hydrocarbylene group that may contain a nitrogen atom and/or an oxygen atom as a heteroatom, and * denotes a bonding position.

The hydrocarbyl group denoted by R⁷ and R⁸ is preferably a hydrocarbyl group having 1 to 10 carbon atoms. Examples of the hydrocarbyl group include an alkyl group and an aryl group. Examples of the alkyl group include a methyl group, an ethyl group, an n-propyl group, an isopropyl group, an n-butyl group, a sec-butyl group, and a tert-butyl group. Examples of the aryl group include a phenyl group. The hydrocarbyl group is preferably an alkyl group, and more preferably an alkyl group having 1 to 4 carbon atoms.

As the trihydrocarbylsilyl group denoted by R⁷ and R⁸, a trialkylsilyl group, etc. can be cited. Examples of the trialkylsilyl group include a trimethylsilyl group, a triethylsilyl group, a triisopropylsilyl group, and a tert-butyldimethylsilyl group. It is preferably a trialkylsilyl group having 3 to 9 carbon atoms, and more preferably a trialkylsilyl group in which the alkyl group bonded to the silicon atom is an alkyl group having 1 to 3 carbon atoms.

Examples of a divalent group in which R⁷ and R⁸ are bonded include an alkylene group such as an ethylene group, a trimethylene group, a tetramethylene group, a pentamethylene group, or a hexamethylene group; a nitrogen atom-containing hydrocarbylene group such as a group represented by —CH₂CH₂—NH—CH₂—, a group represented by —CH₂CH₂—N═CH—, a group represented by —CH═CH—N═CH—, or a group represented by —CH₂CH₂—NH—CH₂CH₂—; and an oxygen atom-containing hydrocarbylene group such as a group represented by —CH₂CH₂—O—CH₂CH₂—.

In the present specification, the hydrocarbylene group means a divalent hydrocarbon residue; the hydrocarbylene group containing an X atom as a heteroatom means a group containing a structure in which a hydrogen atom and/or a carbon atom of a hydrocarbylene group is replaced by an X atom. Examples of a hydrocarbylene group containing a nitrogen atom as a heteroatom include a group containing a structure in which CH of a hydrocarbylene group is replaced by N. Examples of a hydrocarbylene group containing an oxygen atom as a heteroatom include a group containing a structure in which CH₂ is replaced by 0 and a group containing a structure in which two hydrogen atoms are replaced by 0. Examples of a hydrocarbylene group containing a silicon atom as a heteroatom include a group containing a structure in which C is replaced by Si.

As the group represented by Formula (3) above, an acyclic amino group and a cyclic amino group can be cited. Examples of the acyclic amino group include a dialkylamino group such as a dimethylamino group, a diethylamino group, a di(n-propyl)amino group, a di(isopropyl)amino group, a di(n-butyl)amino group, a di(sec-butyl)amino group, a di(tert-butyl)amino group, or an ethylmethylamino group; a diarylamino group such as a diphenylamino group; and a bis(trialkylsilyl)amino group such as a bis(trimethylsilyl)amino group, a bis(triethylsilyl)amino group, a bis(t-butyldimethylsilyl)amino group, or a bis(triisopropylsilyl)amino group.

Examples of the cyclic amino group include a 1-aziridinyl group, a 1-pyrrolidinyl group, a 1-piperidinyl group, a 1-hexamethyleneimino group, a 1-heptamethyleneimino group, a 1-octamethyleneimino group, a 1-decamethyleneimino group, a 1-dodecamethyleneimino group, a 1-imidazolyl group, a 4,5-dihydro-1-imidazolyl group, a 1-imidazolidinyl group, a 1-piperazinyl group, and a morpholino group.

The group represented by Formula (3) is preferably an acyclic amino group, and more preferably a dialkylamino group.

As the hydrocarbyl group denoted by R¹, an alkyl group, an aryl group, etc. can be cited. Examples of the alkyl group include a methyl group, an ethyl group, an n-propyl group, an isopropyl group, an n-butyl group, a sec-butyl group, and a tert-butyl group. Examples of the aryl group include a phenyl group. The hydrocarbyl group is preferably a hydrocarbyl group having 1 to 10 carbon atoms.

The compound represented by Formula (1) is preferably a compound in which r=0 or a compound in which r=1 and R¹ is a hydrocarbyl group, more preferably a compound in which r=0, and yet more preferably a compound in which r=0 and R² is a group represented by Formula (3) above.

Examples of the compound represented by Formula (1) include
1-(4-N,N-dimethylaminophenyl)-1-phenylethylene,
1-(4-N,N-diethylaminophenyl)-1-phenylethylene,
1-(4-N,N-dipropylaminophenyl)-1-phenylethylene,
1-(4-N,N-diisopropylaminophenyl)-1-phenylethylene,
1-(4-N,N-dibutylaminophenyl)-1-phenylethylene,
1-(4-N,N-diisobutylaminophenyl)-1-phenylethylene,
1-(4-N,N-di(tert-butyl)aminophenyl)-1-phenylethylene,
1-(4-N,N-diphenylaminophenyl)-1-phenylethylene,
1-(4-(1-aziridinyl)phenyl)-1-phenylethylene,
1-(4-(1-pyrrolidinyl)phenyl)-1-phenylethylene,
1-(4-(1-piperidinyl)phenyl)-1-phenylethylene,
1-(4-hexamethyleneiminophenyl)-1-phenylethylene,
1-(4-morpholinophenyl)-1-phenylethylene,
1-(4-(N,N-bis(trimethylsilyl)amino)phenyl)-1-phenylethylene,
1-(4-(N,N-bis(tert-butyldimethylsilyl)amino)phenyl)-1-phenylethylene, and
1-(4-(N,N-bistriisopropylsilylamino)phenyl)-1-phenylethylene.

1-(4-N,N-Dimethylaminophenyl)-1-phenylethylene is preferable.

In Formula (2), n denotes an integer of 1 to 10. In order to improve fuel economy, n is preferably not less than 2, and in order to improve economic efficiency, n is preferably not more than 4. n is preferably 3.

In Formula (2), R³, R⁴, and R⁵ independently denote a hydrocarbyl group having 1 to 10 carbon atoms or a hydrocarbyloxy group having 1 to 10 carbon atoms.

Examples of the hydrocarbyl group denoted by R³, R⁴, and R⁵ include an alkyl group such as a methyl group, an ethyl group, an n-propyl group, an isopropyl group, an n-butyl group, a sec-butyl group, or a tert-butyl group. Furthermore, examples of the hydrocarbyloxy group denoted by R³, R⁴, and R⁵ include an alkoxy group such as a methoxy group, an ethoxy group, an n-propoxy group, an isopropoxy group, an n-butoxy group, a sec-butoxy group, or a t-butoxy group. The hydrocarbyl group is preferably an alkyl group having 1 to 3 carbon atoms, and more preferably a methyl group or an ethyl group.

Examples of the hydrocarbyloxy group denoted by R³, R⁴, and R⁵ include an alkoxy group such as a methoxy group, an ethoxy group, a n-propoxy group, an isopropoxy group, a n-butoxy group, a sec-butoxy group, or a tert-butoxy group; and an aryloxy group such as a phenoxy group. It is preferably an alkoxy group having 1 to 3 carbon atoms, and more preferably a methoxy group or an ethoxy group.

At least one of R³, R⁴, and R⁵ is a hydrocarbyloxy group; in order to improve fuel economy it is preferable for at least two of R³, R⁴, and R⁵ to be hydrocarbyloxy groups, and it is more preferable for three of R³, R⁴, and R⁵ to be hydrocarbyloxy groups.

In Formula (2), R⁶ denotes a group containing at least one atom selected from the atomic group consisting of a nitrogen atom, an oxygen atom, and a sulfur atom.

With regard to the group denoted by R⁶ containing at least one atom selected from the atomic group consisting of a nitrogen atom, an oxygen atom, and a sulfur atom, examples of the nitrogen atom-containing group include an amino group and a substituted amino group.

Examples of the substituted amino group include a dihydrocarbylamino group such as a dimethylamino group or a diethylamino group; and a cyclic amino group such as a 1-aziridinyl group, a 1-pyrrolidinyl group, a 1-piperidinyl group, a 1-hexamethyleneimino group, a 1-imidazolyl group, a 4,5-dihydro-1-imidazolyl group, a 1-imidazolidinyl group, a 1-piperazinyl group, or a morpholino group.

Examples of the group containing a nitrogen atom include a heterocyclic group such as 2-pyrrolidyl group, a 2-piperidinyl group, a 2-pyridyl group, a 3-pyridyl group, a 4-pyridyl group, and a 2-pyrazinyl group.

With regard to the group denoted by R⁶ containing at least one atom selected from the atomic group consisting of a nitrogen atom, an oxygen atom, and a sulfur atom, examples of the oxygen atom-containing group include a hydrocarbyloxy group such as an alkoxy group, an aryloxy group, or an aralkyloxy group; a substituted hydrocarbyloxy group such as an alkoxyalkoxy group; and a heterocyclic group containing an oxygen atom as a heteroatom.

Examples of the alkoxy group include a methoxy group, an ethoxy group, an n-propoxy group, an isopropoxy group, an n-butoxy group, a sec-butoxy group, and a tert-butoxy group. Examples of the aryloxy group include a phenoxy group. Examples of the aralkyloxy group include a benzyloxy group.

Examples of the alkoxyalkoxy group include a methoxymethoxy group, a methoxyethoxy group, an ethoxymethoxy group, and an ethoxyethoxy group. Examples of the heterocyclic group containing an oxygen atom as a heteroatom include an oxiranyl group, a tetrahydrofuranyl group, a dioxolanyl group, and a 3,4-epoxycyclohexyl group.

Furthermore, examples of the oxygen atom-containing group include an acryloxy group and a methacryloxy group.

With regard to the group denoted by R⁶ containing at least one atom selected from the atomic group consisting of a nitrogen atom, an oxygen atom, and a sulfur atom, examples of the sulfur atom-containing group include a mercapto group.

R⁶ is preferably a nitrogen atom-containing group, more preferably an optionally substituted amino group, and yet more preferably a group represented by Formula (4) below

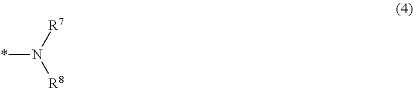

wherein R⁹ and R¹⁰ independently denote a hydrogen atom, a hydrocarbyl group having 1 to 10 carbon atoms, or a group containing 1 to 10 carbon atoms and containing at least one atom selected from the atomic group consisting of a nitrogen atom, an oxygen atom, and a silicon atom, or R⁹ and R¹⁰ are bonded to each other and denote a hydrocarbylene group that may contain at least one atom selected from the atomic group consisting of a nitrogen atom, an oxygen atom, and a silicon atom, and R⁹ and R¹⁰ may be a single group bonded to the nitrogen atom via a double bond.

Examples of the hydrocarbyl group denoted by R⁹ and R¹⁰ include a alkyl group, a aryl group. Examples of the alkyl group include hydrocarbyl group having 1 to 10 carbon atoms. Examples of the hydrocarbyl group include an alkyl group and an aryl group. Examples of the alkyl group include a methyl group, an ethyl group, an n-propyl group, an isopropyl group, an n-butyl group, a sec-butyl group, and a tert-butyl group. Examples of the aryl group include a phenyl group. The hydrocarbyl group is preferably an alkyl group, and more preferably an alkyl group having 1 to 4 carbon atoms and yet more preferably a methyl group or an ethyl group.

As the nitrogen atom-containing group denoted by R⁹ and R¹⁰, a dialkylaminoalkyl group, a heterocyclic group containing a nitrogen atom as a ring-constituting heteroatom, etc. can be cited. Examples of the dialkylaminoalkyl group include a dimethylaminoethyl group and a diethylaminoethyl group. Examples of the heterocyclic group containing a nitrogen atom as a ring-constituting heteroatom include a 2-pyrrolidyl group, a 2-piperidinyl group, a 2-pyridyl group, a 3-pyridyl group, a 4-pyridyl group, and a 2-pyrazinyl group.

As the oxygen atom-containing group denoted by R⁹ and R¹⁰, an alkoxyalkyl group, a heterocyclic group containing an oxygen atom as a ring-constituting heteroatom, etc. can be cited. Examples of the alkoxyalkyl group include a methoxymethyl group, a methoxyethyl group, an ethoxymethyl group, and an ethoxyethyl group. Examples of the heterocyclic group containing an oxygen atom as a ring-constituting heteroatom include a monooxacycloalkyl group such as an oxiranyl group or a tetrahydrofuranyl group; and a dioxacycloalkyl group such as a dioxolanyl group.

Furthermore, examples of the oxygen atom-containing group include an alkyl group substituted with a monooxacycloalkyl group such as a glycidyl group or a tetrahydrofurfuryl group. The oxygen atom-containing group is preferably a heterocyclic group containing an oxygen atom as a ring-constituting heteroatom; or an alkyl group substituted with a monooxacycloalkyl group such as a glycidyl group or a tetrahydrofurfuryl group.

In the present specification, the monooxacycloalkyl group means a group in which one CH₂ of a cycloalkyl group is replaced by an oxygen atom. The dioxacycloalkyl group means a group in which two CH₂s of a cycloalkyl group are replaced by oxygen atoms.

As the silicon atom-containing group denoted by R⁹ and R¹⁰, a trialkylsilyl group, a trialkoxysilyl group, a trialkylsilylalkyl group, etc. can be cited. Examples of the trialkylsilyl group include a trimethylsilyl group, a triethylsilyl group, a tert-butyldimethylsilyl group, and a triisopropylsilyl group. Examples of the trialkoxysilyl group include a trimethoxysilyl group. Examples of the trialkylsilylalkyl group include a trimethylsilylmethyl group. The silicon atom-containing group is preferably a trialkylsilyl group.

Examples of a divalent group in which R⁹ and R¹⁰ are bonded include an alkylene group such as a trimethylene group, a tetramethylene group, a pentamethylene group, or a hexamethylene group; a nitrogen atom-containing hydrocarbylene group such as a group represented by —CH₂CH₂—NH—CH₂—, a group represented by —CH₂CH₂—N═CH—, a group represented by —CH═CH—N═CH—, or a group represented by —CH₂CH₂—NH—CH₂CH₂—; and an oxygen atom-containing hydrocarbylene group such as a group represented by —CH₂CH₂—O—CH₂CH₂—.

Examples of the single group denoted by R⁹ and R¹⁰ that is bonded to the nitrogen atom via a double bond include an ethylidene group, a propylidene group, a butylidene group, a 1-methylethylidene group, a 1-methylpropylidene group, a 1,3-dimethylbutylidene group, and a 4-N,N-dimethylaminobenzylidene group.

The groups denoted by R⁹ and R¹⁰ are preferably hydrocarbyl groups, oxygen atom-containing groups, or silicon atom-containing groups, and more preferably alkyl groups; heterocyclic groups containing an oxygen atom as a ring-constituting heteroatom; alkyl groups substituted with a monooxacycloalkyl group such as a glycidyl group or a tetrahydrofurfuryl group; or trialkylsilyl groups.

As the group represented by Formula (4), an acyclic amino group and a cyclic amino group can be cited. Examples of the acyclic amino group include a dialkylamino group, a bis(alkoxyalkyl)amino group, and a bis(trialkylsilyl)amino group. Examples of the dialkylamino group include a dimethylamino group, a diethylamino group, a di(n-propyl)amino group, a di(isopropyl)amino group, a di(n-butyl)amino group, a di(sec-butyl)amino group, a di(tert-butyl)amino group, a di(neopentyl)amino group, and an ethylmethylamino group. Examples of the bis(alkoxyalkyl)amino group include a bis(methoxymethyl)amino group, a bis(methoxyethyl)amino group, a bis(ethoxymethyl)amino group, and a bis(ethoxyethyl)amino group. Examples of the bis(trialkylsilyl)amino group include a bis(trimethylsilyl)amino group and a bis(t-butyldimethylsilyl)amino group.

Furthermore, examples of the acyclic amino group include a di(oxiranyl)amino group, a di(tetrahydrofuranyl)amino group, a di(glycidyl)amino group, and a di(tetrahydrofurfuryl)amino group.

Moreover, examples of the acyclic amino group include an ethylideneamino group, a 1-methylpropylideneamino group, a 1,3-dimethylbutylideneamino group, a 1-methylethylideneamino group, and a 4-N,N-dimethylaminobenzylideneamino group.

Examples of the cyclic amino group include a 1-aziridinyl group, a 1-pyrrolidinyl group, a 1-piperidinyl group, a hexamethyleneimino group, a 1-imidazolyl group, a 4,5-dihydro-1-imidazolyl group, a 1-imidazolidinyl group, a 1-piperazinyl group, and a morpholino group.

The group represented by Formula (4) is preferably an acyclic amino group, and more preferably a dialkylamino group, a di(oxiranyl)amino group, a di(tetrahydrofuranyl)amino group, a di(glycidyl)amino group, a di(tetrahydrofurfuryl)amino group, or a di(trialkylsilyl)amino group.

With regard to the compound represented by Formula (2), as a compound in which Formula (4) is an acyclic amino group, the following compounds can be cited as examples.

Examples of compounds in which Formula (4) is a dialkylamino group include
[3-(dimethylamino)propyl]trimethoxysilane,
[3-(diethylamino)propyl]trimethoxysilane,
[3-(ethylmethylamino)propyl]trimethoxysilane,
[3-(dimethylamino)propyl]triethoxysilane,
[3-(diethylamino)propyl]triethoxysilane, and
[3-(dialkylamino)propyl]trialkoxysilanes such as
[3-(ethylmethylamino)propyl]triethoxysilane;
[3-(dimethylamino)propyl]methyldimethoxysilane,
[3-(diethylamino)propyl]methyldimethoxysilane,
[3-(ethylmethylamino)propyl]methyldimethoxysilane,
[3-(dimethylamino)propyl]ethyldimethoxysilane,
[3-(diethylamino)propyl]ethyldimethoxysilane,
[3-(ethylmethylamino)propyl]ethyldimethoxysilane,
[3-(dimethylamino)propyl]methyldiethoxysilane,
[3-(diethylamino)propyl]methyldiethoxysilane,
[3-(ethylmethylamino)propyl]methyldiethoxysilane,
[3-(dimethylamino)propyl]ethyldiethoxysilane,
[3-(diethylamino)propyl]ethyldiethoxysilane, and
[3-(dialkylamino)propyl]alkyldialkoxysilanes such as
[3-(ethylmethylamino)propyl]ethyldiethoxysilane,
[3-(dialkylamino)propyl]dialkylalkoxysilanes such as
[3-(dimethylamino)propyl]dimethylmethoxysilane,
[3-(diethylamino)propyl]dimethylmethoxysilane,
[3-(dimethylamino)propyl]diethylmethoxysilane,
[3-(diethylamino)propyl]diethylethoxysilane,
[3-(dimethylamino)propyl]dimethylethoxysilane,
[3-(diethylamino)propyl]dimethylethoxysilane,
[3-(dimethylamino)propyl]diethylethoxysilane, and
[3-(diethylamino)propyl]diethylethoxysilane.

Examples of compounds in which Formula (4) is a bis(alkoxyalkyl)amino group include
{3-[bis(alkoxyalkyl)amino]propyl}trialkoxysilanes such as
{3-[bis(methoxymethyl)amino]propyl}trimethoxysilane,
{3-[bis(ethoxymethyl)amino]propyl}trimethoxysilane,
{3-[bis(methoxyethyl)amino]propyl}trimethoxysilane,
{3-[bis(ethoxyethyl)amino]propyl}trimethoxysilane,
{3-[bis(methoxymethyl)amino]propyl}triethoxysilane,
{3-[bis(ethoxymethyl)amino]propyl}triethoxysilane,
{3-[bis(methoxyethyl)amino]propyl}triethoxysilane, and
{3-[bis(ethoxyethyl)amino]propyl}triethoxysilane;
{3-[bis(alkoxyalkyl)amino]propyl}alkyldialkoxysilanes such as
{3-[bis(methoxymethyl)amino]propyl}methyldimethoxysilane,
{3-[bis(ethoxymethyl)amino]propyl}methyldimethoxysilane,
{3-[bis(methoxyethyl)amino]propyl}methyldimethoxysilane,
{3-[bis(ethoxyethyl)amino]propyl}methyldimethoxysilane,
{3-[bis(methoxymethyl)amino]propyl}ethyldimethoxysilane,
{3-[bis(ethoxymethyl)amino]propyl}ethyldimethoxysilane,
{3-[bis(methoxymethyl)amino]propyl}methyldiethoxysilane,
{3-[bis(ethoxymethyl)amino]propyl}methyldiethoxysilane,
{3-[bis(methoxymethyl)amino]propyl}ethyldiethoxysilane,
{3-[bis(ethoxymethyl)amino]propyl}ethyldiethoxysilane,
{3-[bis(methoxyethyl)amino]propyl}ethyldiethoxysilane, and
{3-[bis(ethoxyethyl)amino]propyl}ethyldiethoxysilane;
{3-[bis(alkoxyalkyl)amino]propyl}dialkylalkoxysilanes such as
{3-[bis(methoxymethyl)amino]propyl}dimethylmethoxysilane,
{3-[bis(ethoxymethyl)amino]propyl}dimethylmethoxysilane,
{3-[bis(methoxyethyl)amino]propyl}dimethylmethoxysilane,
{3-[bis(ethoxyethyl)amino]propyl}dimethylmethoxysilane,
{3-[bis(methoxymethyl)amino]propyl}diethylmethoxysilane,
{3-[bis(ethoxymethyl)amino]propyl}diethylmethoxysilane,
{3-[bis(methoxyethyl)amino]propyl}diethylmethoxysilane,
{3-[bis(ethoxyethyl)amino]propyl}diethylmethoxysilane,
{3-[bis(methoxymethyl)amino]propyl}dimethylethoxysilane,
{3-[bis(ethoxymethyl)amino]propyl}dimethylethoxysilane,
{3-[bis(methoxyethyl)amino]propyl}dimethylethoxysilane,
{3-[bis(ethoxyethyl)amino]propyl}dimethylethoxysilane,
{3-[bis(methoxymethyl)amino]propyl}diethylethoxysilane,
{3-[bis(ethoxymethyl)amino]propyl}diethylethoxysilane,
{3-[bis(methoxyethyl)amino]propyl}diethylethoxysilane, and
{3-[bis(ethoxyethyl)amino]propyl}diethylethoxysilane.

Examples of compounds in which Formula (4) is a di(oxiranyl)amino group include
{3-[di(oxiranyl)amino]propyl}trimethoxysilane,
{3-[di(oxiranyl)amino]propyl}triethoxysilane,
{3-[di(oxiranyl)amino]propyl}methyldimethoxysilane,
{3-[di(oxiranyl)amino]propyl}ethyldimethoxysilane,
{3-[di(oxiranyl)amino]propyl}methyldiethoxysilane,
{3-[di(oxiranyl)amino]propyl}ethyldiethoxysilane,
{3-[di(oxiranyl)amino]propyl}dimethylmethoxysilane,
{3-[di(oxiranyl)amino]propyl}diethylmethoxysilane,
{3-[di(oxiranyl)amino]propyl}dimethylethoxysilane, and
{3-[di(oxiranyl)amino]propyl}diethylethoxysilane.

Examples of compounds in which Formula (4) is a di(tetrahydrofuranyl)amino group include
{3-[di(tetrahydrofuranyl)amino]propyl}trimethoxysilane,
{3-[di(tetrahydrofuranyl)amino]propyl}triethoxysilane,
{3-[di(tetrahydrofuranyl)amino]propyl}methyldimethoxysilane,
{3-[di(tetrahydrofuranyl)amino]propyl}ethyldimethoxysilane,
{3-[di(tetrahydrofuranyl)amino]propyl}methyldiethoxysilane,
{3-[di(tetrahydrofuranyl)amino]propyl}ethyldiethoxysilane,
{3-[di(tetrahydrofuranyl)amino]propyl}dimethylmethoxysilane,
{3-[di(tetrahydrofuranyl)amino]propyl}diethylmethoxysilane,
{3-[di(tetrahydrofuranyl)amino]propyl}dimethylethoxysilane, and
{3-[di(tetrahydrofuranyl)amino]propyl}diethylethoxysilane.

Examples of compounds in which Formula (4) is a di(glycidyl)amino group include
{3-[di(glycidyl)amino]propyl}trimethoxysilane,
{3-[di(glycidyl)amino]propyl}triethoxysilane,
{3-[di(glycidyl)amino]propyl}methyldimethoxysilane,
{3-[di(glycidyl)amino]propyl}ethyldimethoxysilane,
{3-[di(glycidyl)amino]propyl}methyldiethoxysilane,
{3-[di(glycidyl)amino]propyl}ethyldiethoxysilane,
{3-[di(glycidyl)amino]propyl}dimethylmethoxysilane,
{3-[di(glycidyl)amino]propyl}diethylmethoxysilane,
{3-[di(glycidyl)amino]propyl}dimethylethoxysilane and
{3-[di(glycidyl)amino]propyl}diethylethoxysilane.

Examples of compounds in which Formula (4) is a di(tetrahydrofurfuryl)amino group include
{3-[di(tetrahydrofurfuryl)amino]propyl}trimethoxysilane,
{3-[di(tetrahydrofurfuryl)amino]propyl}triethoxysilane,
{3-[di(tetrahydrofurfuryl)amino]propyl}methyldimethoxysilane,
{3-[di(tetrahydrofurfuryl)amino]propyl}ethyldimethoxysilane,
{3-[di(tetrahydrofurfuryl)amino]propyl}methyldiethoxysilane,
{3-[di(tetrahydrofurfuryl)amino]propyl}ethyldiethoxysilane,
{3-[di(tetrahydrofurfuryl)amino]propyl}dimethylmethoxysilane,
{3-[di(tetrahydrofurfuryl)amino]propyl}diethylmethoxysilane,
{3-[di(tetrahydrofurfuryl)amino]propyl}dimethylethoxysilane, and
{3-[di(tetrahydrofurfuryl)amino]propyl}diethylethoxysilane.

Examples of compounds in which Formula (4) is a di(trialkylsilyl)amino group include
{3-[di(trialkylsilyl)amino]propyl}trialkoxysilanes such as
{3-[di(trimethylsilyl)amino]propyl}trimethoxysilane,
{3-[di(t-butyldimethylsilyl)amino]propyl}trimethoxysilane,
{3-[di(trimethylsilyl)amino]propyl}triethoxysilane, and
{3-[di(t-butyldimethylsilyl)amino]propyl}triethoxysilane;
{3-[di(trialkylsilyl)amino]propyl}alkyldialkoxysilanes such as
{3-[di(trimethylsilyl)amino]propyl}methyldimethoxysilane,
{3-[di(t-butyldimethylsilyl)amino]propyl}methyldimethoxysilane,
{3-[di(trimethylsilyl)amino]propyl}methyldiethoxysilane, and
{3-[di(t-butyldimethylsilyl)amino]propyl}methyldiethoxysilane; and
{3-[di(trialkylsilyl)amino]propyl}dialkylalkoxysilanes such as
{3-[di(trimethylsilyl)amino]propyl}dimethylmethoxysilane,
{3-[di(t-butyldimethylsilyl)amino]propyl}dimethylmethoxysilane,
{3-[di(trimethylsilyl)amino]propyl}dimethylethoxysilane, and
{3-[di(t-butyldimethylsilyl)amino]propyl}dimethylethoxysilane.

Among them, a [3-(dialkylamino)propyl]trialkoxysilane is preferable, and
[3-(dimethylamino)propyl]trimethoxysilane,
[3-(diethylamino)propyl]trimethoxysilane,
[3-(dimethylamino)propyl]triethoxysilane, and
[3-(diethylamino)propyl]triethoxysilane are more preferable.

Furthermore, examples of the compound represented by Formula (2) include a compound in which Formula (4) is a cyclic amino group such as a 1-piperidino group, a 1-hexamethyleneimino group, a morpholino group, a 1-imidazolyl group, or a 4,5-dihydro-1-imidazolyl group.

Examples of compounds in which Formula (4) is a 1-piperidino group include
3-(1-piperidino)propyltrimethoxysilane,
3-(1-piperidino)propyltriethoxysilane,
3-(1-piperidino)propylmethyldimethoxysilane,
3-(1-piperidino)propylethyldimethoxysilane,
3-(1-piperidino)propylmethyldiethoxysilane, and
3-(1-piperidino)propylethyldiethoxysilane.

Examples of compounds in which Formula (4) is a 1 hexamethyleneimino group include
3-(1-hexamethyleneimino)propyltrimethoxysilane,
3-(1-hexamethyleneimino)propyltriethoxysilane,
3-(1-hexamethyleneimino)propylmethyldimethoxysilane,
3-(1-hexamethyleneimino)propylethyldimethoxysilane,
3-(1-hexamethyleneimino)propylmethyldiethoxysilane, and
3-(1-hexamethyleneimino)propylethyldiethoxysilane.

Examples of compounds in which Formula (4) is a morpholino group include
3-morpholinopropyltrimethoxysilane,
3-morpholinopropyltriethoxysilane,
3-morpholinopropylmethyldimethoxysilane,
3-morpholinopropylethyldimethoxysilane,
3-morpholinopropylmethyldiethoxysilane, and
3-morpholinopropylethyldiethoxysilane.

Examples of compounds in which Formula (4) is a 1-imidazolyl group include N-(3-trimethoxysilylpropyl)imidazole, and N-(3-triethoxysilylpropyl)imidazole.

Examples of compounds in which Formula (4) is a 4,5-dihydro-1-imidazolyl group include
N-(3-trimethoxysilylpropyl)-4,5-dihydroimidazole, and
N-(3-triethoxysilylpropyl)-4,5-dihydroimidazole.

Among them, a compound in which Formula (4) is a 1-imidazolyl group and a compound in which Formula (IIa) is a 4,5-dihydro-1-imidazolyl group are preferable, and
N-(3-trimethoxysilylpropyl)imidazole,
N-(3-triethoxysilylpropyl)imidazole,
N-(3-trimethoxysilylpropyl)-4,5-dihydroimidazole, and
N-(3-triethoxysilylpropyl)-4,5-dihydroimidazole are more preferable.

In order to improve abrasion resistance, the conjugated diene polymer of the present invention preferably contains a monomer unit based on a monomer represented by Formula (1) between a conjugated diene-based monomer unit-containing partial chain (not containing a monomer unit based on a compound represented by Formula (1)) and a conjugated diene-based monomer unit-containing partial chain (not containing a monomer unit based on a compound represented by Formula (1)).

In order to increase strength, the conjugated diene polymer of the present invention preferably contains a vinyl aromatic hydrocarbon-based monomer unit (vinyl aromatic hydrocarbon unit). Examples of the vinyl aromatic hydrocarbon include styrene, α-methylstyrene, vinyltoluene, vinylnaphthalene, divinylbenzene, trivinylbenzene, and divinylnaphthalene.

It is preferably styrene.

From the viewpoint of strength the conjugated diene polymer of the present invention preferably contains an aromatic vinyl-based constituent unit (aromatic vinyl unit), and the content of the aromatic vinyl unit, relative to 100% by weight of the total amount of the conjugated diene unit and the aromatic vinyl unit, is preferably at least 10% by weight (the content of the conjugated diene unit being no greater than 90% by weight), and more preferably at least 15% by weight (the content of the conjugated diene unit being no greater than 85% by weight). Furthermore, from the viewpoint of fuel economy, the content of the aromatic vinyl unit is preferably no greater than 50% by weight (the content of the conjugated diene unit being at least 50% by weight), and more preferably no greater than 45% by weight (the content of the conjugated diene unit being at least 55% by weight).

From the viewpoint of strength, the Mooney viscosity (ML₁₊₄) of the conjugated diene polymer of the present invention is preferably at least 10, and more preferably at least 20. Furthermore, from the viewpoint of processability, it is preferably no greater than 200, and more preferably no greater than 150. The Mooney viscosity (ML1+4) is measured at 100° C. in accordance with JIS K6300 (1994).

From the viewpoint of fuel economy, the vinyl bond content of the conjugated diene polymer of the present invention, with the content of the conjugated diene unit as 100% by mol, is preferably no greater than 80% by mol, and more preferably no greater than 70% by mol. Furthermore, from the viewpoint of grip properties, it is preferably at least 10% by mol, more preferably at least 15% by mol, yet more preferably at least 20% by mol, and particularly preferably at least 40% by mol. The vinyl bond content may be obtained by IR spectroscopy from the absorption intensity at around 910 cm-1, which is an absorption peak of a vinyl group.

The content of the monomer unit based on a compound represented by Formula (1) is, in order to improve abrasion resistance, preferably not less than 0.01% by weight relative to 100% by weight of the conjugated diene polymer, and more preferably not less than 0.02% by weight. Furthermore, in order to improve economic efficiency it is preferably not more than 2% by weight, and more preferably not more than 1% by weight.

From the viewpoint of fuel economy, the molecular weight distribution of the conjugated diene polymer of the present invention is preferably 1 to 5, and more preferably 1 to 2. The molecular weight distribution is obtained by measuring number-average molecular weight (Mn) and weight-average molecular weight (Mw) by a gel permeation chromatograph (GPC) method, and dividing Mw by Mn.

As a preferred method for producing the conjugated diene polymer of the present invention, a production method including steps A and B below can be cited.

(Step A): a step of polymerizing monomer components including a conjugated diene and a compound represented by Formula (1) above in a hydrocarbon solvent by an alkali metal catalyst, thus giving a polymer having an alkali metal catalyst-derived alkali metal in at least one terminus of a polymer chain
(Step B): a step of reacting the polymer obtained in step A and a compound represented by Formula (2) above

As the alkali metal catalyst used in step A there can be cited an alkali metal, an organoalkali metal compound, a complex between an alkali metal and a polar compound, an oligomer having an alkali metal, etc. Examples of the alkali metal include lithium, sodium, potassium, rubidium, and cesium. Examples of the organoalkali metal compound include ethyllithium, n-propyllithium, iso-propyllithium, n-butyllithium, sec-butyllithium, t-octyllithium, n-decyllithium, phenyllithium, 2-naphthyllithium, 2-butylphenyllithium, 4-phenylbutyllithium, cyclohexyllithium, 4-cyclopentyllithium, dimethylaminopropyllithium, diethylaminopropyllithium, t-butyldimethylsilyloxypropyllithium, N-morpholinopropyllithium, lithium hexamethyleneimide, lithium pyrrolidide, lithium piperidide, lithium heptamethyleneimide, lithium dodecamethyleneimide, 1,4-dilithio-2-butene, sodium naphthalenide, sodium biphenylide, and potassium naphthalenide. Examples of the complex between an alkali metal and a polar compound include a potassium-tetrahydrofuran complex and a potassium-diethoxyethane complex, and examples of the oligomer having an alkali metal include the sodium salt of a-methylstyrene tetramer. An organolithium compound or an organosodium compound is preferable, and an organolithium compound having 2 to 20 carbon atoms or an organosodium compound having 2 to 20 carbon atoms is more preferable.

The hydrocarbon solvent used in step A is a solvent that does not deactivate the organoalkali metal compound catalyst, and an aliphatic hydrocarbon, an aromatic hydrocarbon, an alicyclic hydrocarbon, etc. can be cited. Examples of the aliphatic hydrocarbon include propane, n-butane, iso-butane, n-pentane, iso-pentane, n-hexane, propene, 1-butene, iso-butene, trans-2-butene, cis-2-butene, 1-pentene, 2-pentene, 1-hexene, and 2-hexene. Examples of the aromatic hydrocarbon include benzene, toluene, xylene, and ethylbenzene, and examples of the alicyclic hydrocarbon include cyclopentane and cyclohexane. One or more types thereof may be used. The hydrocarbon solvent may be a mixture of various types of components, as in industrial hexane. The hydrocarbon solvent is preferably a hydrocarbon having 2 to 12 carbon atoms, and more preferably an aliphatic saturated hydrocarbon having 5 to 8 carbon atoms.

In step A, monomer components including a conjugated diene and a compound represented by Formula (1) above are polymerized in a hydrocarbon solvent by an alkali metal catalyst, thus producing a polymer having an alkali metal derived from the catalyst in at least one terminus of a polymer chain containing a conjugated diene-based monomer unit and a monomer unit based on a compound represented by Formula (1) above. Examples of the conjugated diene include 1,3-butadiene, isoprene, 1,3-pentadiene, 2,3-dimethyl-1,3-butadiene, and 1,3-hexadiene. One or more types thereof may be used. It is preferably 1,3-butadiene or isoprene.

The amount of compound represented by Formula (1) used relative to 100% by weight of the total amount of monomer components used in polymerization is, in order to improve abrasion resistance, preferably not less than 0.01% by weight, and more preferably not less than 0.02% by weight. Furthermore, in order to improve economic efficiency, it is preferably not more than 2% by weight, and preferably not more than 1% by weight.

In step A, polymerization may be carried out by combining, as monomers, the conjugated diene and the compound represented by Formula (1) with a vinyl aromatic hydrocarbon, and examples of the vinyl aromatic hydrocarbon include styrene, α-methylstyrene, vinyltoluene, vinylnaphthalene, divinylbenzene, trivinylbenzene, and divinylnaphthalene. It is preferably styrene.

The amount of vinyl aromatic hydrocarbon used relative to 100% by weight of the total amount of conjugated diene and vinyl aromatic hydrocarbon used is not less than 0% by weight (the amount of conjugated diene used being not more than 100% by weight), and in order to improve strength it is preferably not less than 10% by weight (the amount of conjugated diene used being not more than 90% by weight), and more preferably not less than 15% by weight (the amount of conjugated diene used being not more than 85% by weight). Furthermore, in order to improve fuel economy, the amount of vinyl aromatic hydrocarbon used is preferably not more than 50% by weight (the amount of conjugated diene used being not less than 50% by weight), and more preferably not more than 45% by weight (the amount of conjugated diene used being not less than 55% by weight).

The polymerization in step A may be carried out in the presence of an agent for regulating the vinyl bond content of the conjugated diene unit, an agent for regulating the distribution in the conjugated diene polymer chain of the conjugated diene unit and a monomer unit based on a monomer other than the conjugated diene (hereafter, generally called ‘regulators’), etc. Examples of such regulators include an ether compound, a tertiary amine, and a phosphine compound. Specific examples of the ether compound include cyclic ethers such as tetrahydrofuran, tetrahydropyran, and 1,4-dioxane; aliphatic monoethers such as diethyl ether and dibutyl ether; aliphatic diethers such as ethylene glycol dimethyl ether, ethylene glycol diethyl ether, ethylene glycol dibutyl ether, diethylene glycol diethyl ether, and diethylene glycol dibutyl ether; and aromatic ethers such as diphenyl ether and anisole. Specific examples of the tertiary amine include triethylamine, tripropylamine, tributylamine, N,N,N′,N′-tetramethylethylenediamine, N,N-diethylaniline, pyridine, and quinoline. Specific examples of the phosphine compound include trimethylphosphine, triethylphosphine, and triphenylphosphine. One or more types thereof may be used.

The polymerization temperature in step A is usually from 25° C. to 100° C., preferably from 35° C. to 90° C., and yet more preferably from 50° C. to 80° C. The polymerization time is usually from 10 minutes to 5 hours.

Step A preferably includes steps a1, a2, and a3 below.

(Step a1): a step of polymerizing a monomer component including a conjugated diene in a hydrocarbon solvent by an alkali metal catalyst, thus giving a conjugated diene polymer having an alkali metal derived from the catalyst in a polymer chain terminus
(Step a2): a step of adding a compound represented by Formula (1) to a hydrocarbon solution of the conjugated diene polymer having an alkali metal derived from the alkali metal catalyst in a polymer chain terminus to thus react the vinyl compound with the polymer chain terminus, thus giving a conjugated diene polymer having in a polymer chain terminus a structure in which the alkali metal derived from the alkali metal catalyst is bonded to a monomer unit based on the compound represented by Formula (1)
(Step a3): a step of adding a monomer component including a conjugated diene to a hydrocarbon solution of the conjugated diene polymer having in a polymer chain terminus a structure in which the alkali metal derived from the alkali metal catalyst is bonded to a monomer unit based on the compound represented by Formula (1), thus polymerizing the monomer component at the polymer chain terminus

In step B, the amount of compound represented by Formula (2) that is reacted with the polymer prepared in step A per mole of alkali metal derived from an organic alkali metal catalyst is usually from 0.1 to 3 mole, preferably from 0.5 to 2 mole, and more preferably from 0.7 to 1.5 mole.

The temperature at which the polymer prepared in step A and a compound represented by Formula (2) are reacted in step B is usually from 25° C. to 100° C., preferably from 35° C. to 90° C., and yet more preferably from 50° C. to 80° C. The time for the reaction is usually from 60 sec to 5 hours, preferably from 5 minutes to 1 hour, and more preferably from 15 minutes to 1 hour.

In the production method of the present invention, a coupling agent may be added to the hydrocarbon solution of the conjugated diene polymer as necessary from initiation of polymerization of monomer by an alkali metal catalyst to termination of polymerization. Examples of the coupling agent include a compound represented by Formula (7) below.

R¹¹ₐML₄₋ₐ (7)

wherein R₁₁ denotes an alkyl group, an alkenyl group, a cycloalkenyl group, or an aromatic residue, M denotes a silicon atom or a tin atom, L denotes a halogen atom or a hydrocarbyloxy group, and a denotes an integer of 0 to 2.

Here, the aromatic residue denotes a monovalent group in which a hydrogen atom bonded to an aromatic ring is removed from an aromatic hydrocarbon.

Examples of the coupling agent represented by Formula (7) include silicon tetrachloride, methyltrichlorosilane, dimethyldichlorosilane, trimethylchlorosilane, tin tetrachloride, methyltrichlorotin, dimethyldichlorotin, trimethylchlorotin, tetramethoxysilane, methyltrimethoxysilane, dimethoxydimethylsilane, methyltriethoxysilane, ethyltrimethoxysilane, dimethoxydiethylsilane, diethoxydimethylsilane, tetraethoxysilane, ethyltriethoxysilane, and diethoxydiethylsilane.

In order to improve the processability of the conjugated diene polymer, the amount of coupling agent added is preferably not less than 0.03 mol per mol of the alkali metal originating from the alkali metal catalyst, and more preferably not less than 0.05 mol. Furthermore, in order to improve fuel economy, it is preferably not more than 0.4 mol, and more preferably not more than 0.3 mol.

The conjugated diene polymer may be recovered from the hydrocarbon solution of the conjugated diene polymer by a known recovery method such as, for example, (1) a method in which a coagulant is added to the hydrocarbon solution of the conjugated diene polymer or (2) a method in which steam is added to the hydrocarbon solution of the conjugated diene polymer. The conjugated diene polymer thus recovered may be dried by a known dryer such as a band dryer or an extrusion dryer.

The conjugated diene polymer of the present invention may be used in a conjugated diene polymer composition by mixing another polymer component, an additive, etc. therewith.

Examples of said other polymer component include conventional styrene-butadiene copolymer rubber, polybutadiene rubber, butadiene-isoprene copolymer rubber, and butyl rubber. Examples further include natural rubber, an ethylene-propylene copolymer, and an ethylene-octene copolymer. One or more types of these polymer components may be used.

In the case where another polymer component is added to the conjugated diene polymer of the present invention, in order to improve abrasion resistance, the content of the conjugated diene polymer of the present invention, with the total content of polymer components (including the conjugated diene polymer content) as 100 parts by weight, is preferably not less than 10 parts by weight, and more preferably not less than 20 parts by weight.

As the additive, a known additive may be used, and examples thereof include a vulcanizer such as sulfur; a vulcanizing accelerator such as a thiazole-based vulcanizing accelerator, a thiuram-based vulcanizing accelerator, a sulfenamide-based vulcanizing accelerator, or a guanidine-based vulcanizing accelerator; a vulcanizing activator such as stearic acid or zinc oxide; an organic peroxide; a reinforcing agent such as silica or carbon black; a filler such as calcium carbonate, talc, alumina, clay, aluminum hydroxide, or mica; a silane coupling agent; an extender oil; a processing coagent; an antioxidant; and a lubricant.

Examples of the silica include dry silica (anhydrous silicic acid), wet silica (hydrated silicic acid), colloidal silica, precipitated silica, calcium silicate, and aluminum silicate. One or more type thereof may be used. The BET specific surface area of the silica is preferably 50 to 250 m2/g. The BET specific surface area is measured in accordance with ASTM D1993-03. As a commercial product, trade name Ultrasil VN3-G manufactured by Degussa, Inc., trade names VN3, AQ, ER, and RS-150 manufactured by Tosoh Silica Corporation, trade names Zeosil 1115 MP and 1165 MP manufactured by Rhodia, etc. may be used.

Examples of the carbon black include furnace black, acetylene black, thermal black, channel black, and graphite. With regard to the carbon black, channel carbon black such as EPC, MPC, or CC; furnace carbon black such as SAF, ISAF, HAF, MAF, FEF, SRF, GPF, APF, FF, CF, SCF, or ECF; thermal carbon black such as FT or MT; and acetylene carbon black can be cited as examples. One or more type thereof may be used.

The nitrogen adsorption specific surface area (N2SA) of the carbon black is preferably 5 to 200 m²/g, and the dibutyl phthalate (DBP) absorption of the carbon black is preferably 5 to 300 ml/100 g. The nitrogen adsorption specific surface area is measured in accordance with ASTM D4820-93, and the DBP absorption is measured in accordance with ASTM D2414-93. As a commercial product, trade name DIABLACK N339 manufactured by Mitsubishi Chemical Corp., trade names SEAST 6, SEAST 7HM, and SEAST KH manufactured by Tokai Carbon Co., Ltd., and trade names CK 3 and Special Black 4A manufactured by Degussa, Inc., etc. may be used.

Examples of the silane coupling agent include vinyltrichlorosilane, vinyltriethoxysilane, vinyltris(β-methoxyethoxy)silane, β-(3,4-epoxycyclohexypethyltrimethoxysilane, γ-glycidoxypropyltrimethoxysilane, γ-methacryloxypropyltrimethoxysilane, N-(β-aminoethyl)-γ-aminopropyltrimethoxysilane, N-(β-aminoethyl)-γ-aminopropylmethyldimethoxysilane, N-phenyl-γ-aminopropyltrimethoxysilane, γ-chloropropyltrimethoxysilane, γ-mercaptopropyltrimethoxysilane, γ-aminopropyltriethoxysilane, bis(β-(triethoxysilyl)propyl)disulfide, bis(β-(triethoxysilyl)propyl)tetrasulfide, γ-trimethoxysilylpropyldimethylthiocarbamyl tetrasulfide, and γ-trimethoxysilylpropylbenzothiazyl tetrasulfide. One or more type thereof may be used. As a commercial product, trade names Si69 and Si75 manufactured by Degussa, Inc., etc. may be used.

Examples of the extender oil include an aromatic mineral oil (viscosity-gravity constant (V.G.C. value) 0.900 to 1.049), a naphthenic mineral oil (V.G.C. value 0.850 to 0.899), and a paraffinic mineral oil (V.G.C. value 0.790 to 0.849). The polycyclic aromatic content of the extender oil is preferably less than 3% by weight, and more preferably less than 1% by weight. The polycyclic aromatic content is measured in accordance with British Institute of Petroleum method 346/92. Furthermore, the aromatic compound content (CA) of the extender oil is preferably not less than 20% by weight. One or more types of the extender oil may be used.

Examples of the vulcanization accelerator include thiazole-based vulcanization accelerators such as 2-mercaptobenzothiazole, dibenzothiazyl disulfide, and N-cyclohexyl-2-benzothiazylsulfenamide; thiuram-based vulcanization accelerators such as tetramethylthiuram monosulfide and tetramethylthiuram disulfide; sulfenamide-based vulcanization accelerators such as N-cyclohexyl-2-benzothiazolesulfenamide, N-t-butyl-2-benzothiazolesulfenamide, N-oxyethylene-2-benzothiazolesulfenamide, N-oxyethylene-2-benzothiazolesulfenamide, and N,N′-diisopropyl-2-benzothiazolesulfenamide; and guanidine-based vulcanization accelerators such as diphenylguanidine, diorthotolylguanidine and orthotolylbiguanidine. The amount thereof used is preferably 0.1 to 5 parts by weight, and more preferably 0.2 to 3 parts by weight relative to 100 parts by weight of the total amount of polymer components combined (including the amount of conjugated diene polymer combined) rubber component.

When a conjugated diene polymer composition is formed by adding a reinforcing agent with the conjugated diene polymer of the present invention, the amount of the reinforcing agent added, relative to 100 parts by weight of the conjugated diene polymer of the present invention added, is preferably 10 to 150 parts by weight. In order to improve abrasion resistance and strength, the amount added is more preferably not less than 20 parts by weight, and yet more preferably not less than 30 parts by weight. In order to enhance reinforcement, it is preferably not more than 120 parts by weight, and more preferably not more than 100 parts by weight.

When a conjugated diene polymer composition in which a reinforcing agent is added to the conjugated diene polymer of the present invention is used, in order to improve fuel economy, it is preferable to use silica as a reinforcing agent. The amount of silica added is preferably not less than 50 parts by weight relative to 100 parts by weight of the total amount of reinforcing agents added, and more preferably not less than 70 parts by weight and most preferably not more than 100 parts by weight.

When a conjugated diene polymer composition is formed by adding a silane coupling agent to the conjugated diene polymer of the present invention, the content of the silane coupling agent per 100 parts by weight of silica is preferably from 1 to 20 parts by weight, more preferably from 2 to 15 parts by weight, and yet more preferably from 5 to 10 parts by weight.

As a method for producing a conjugated diene polymer composition by adding to another polymer component, an additive, etc. with the conjugated diene polymer of the present invention, a known method such as, for example, a method in which the components are kneaded by means of a known mixer such as a roll or Banbury mixer can be used.

With regard to kneading conditions, when an additive other than a vulcanizing agent or a vulcanization accelerator is added, the kneading temperature is preferably 50° C. to 200° C. and more preferably 80° C. to 190° C., and the kneading time is preferably 30 sec to 30 min and more preferably 1 min to 30 min. When a vulcanizing agent or a vulcanization accelerator is added, the kneading temperature is preferably not more than 100° C., and more preferably room temperature to 80° C. A composition in which a vulcanizing agent or a vulcanization accelerator is added is usually used after carrying out a vulcanization treatment such as press vulcanization. The vulcanization temperature is preferably 120° C. to 200° C., and more preferably 140° C. to 180° C.

The conjugated diene polymer and the conjugated diene polymer composition of the present invention have excellent abrasion resistance. The fuel economy is also good.

The conjugated diene polymer and the conjugated diene polymer composition of the present invention are used for tires, shoe soles, flooring materials, vibration-proofing materials, etc., and are particularly suitably used for tires.

### EXAMPLES

The present invention is explained below by reference to Examples. Physical properties were evaluated by the following methods.

### 1. Mooney Viscosity (ML₁₊₄)

The Mooney viscosity of a polymer was measured at 100° C. in accordance with JIS K₆₃₀₀ (1994).

### 2. Vinyl Bond Content (Units: mol %)

The vinyl bond content of a polymer was determined by IR spectroscopy from the absorption intensity at around 910 cm⁻¹, which is an absorption peak of a vinyl group.

### 3. Styrene Unit Content (Units: % by Weight)

The styrene unit content of a polymer was determined from refractive index in accordance with JIS K6383 (1995).

### 4. Molecular Weight Distribution (Mw/Mn)

Weight-average molecular weight (Mw) and number-average molecular weight (Mn) were measured under conditions (1) to (8) below by a gel permeation chromatograph (GPC) method, and the molecular weight distribution (Mw/Mn) of a polymer was determined.

(1) Instrument: HLC-8220 manufactured by Tosoh Corporation
(2) Separation column: HM-H (2 columns in tandem) manufactured by Tosoh Corporation
(3) Measurement temperature: 40° C.
(4) Carrier: tetrahydrofuran
(5) Flow rate: 0.6 mL/min
(6) Amount injected: 5 μL
(7) Detector: differential refractometer
(8) Molecular weight standard: standard polystyrene

### 5. Abrasion Resistance

A ring-shaped vulcanized molded body was used as a test piece; the amounts abraded under conditions of a load of 10 pounds and a test piece rotational speed of 300 rpm for 500 to 1,500 rotations, 1,500 to 2,500 rotations, and 2,500 to 3,500 rotations were measured using an Akron abrasion tester (Ueshima Seisakusho Co., Ltd.), and the average value thereof was calculated. The smaller this value, the better the abrasion resistance.

### 6. Fuel Economy

A strip-shaped test piece having a width of 1 or 2 mm and a length of 40 mm was stamped out from a sheet-shaped vulcanized molding and used for testing. The loss tangent (tand (70° C.)) at 70° C. of the test piece was measured using a viscoelastometer (Ueshima Seisakusho Co., Ltd.) under conditions of a strain of 1% and a frequency of 10 Hz. The smaller this value, the better the fuel economy.

### Example 1

A 20 liter capacity stainless polymerization reactor equipped with a stirrer was washed, dried, and flushed with dry nitrogen. Subsequently, the polymerization reactor was charged with 10.2 kg of industrial hexane (density 680 kg/m3), 608 g of 1,3-butadiene, 192 g of styrene, 6.1 mL of tetrahydrofuran, and 4.12 mL of ethylene glycol diethyl ether. Subsequently, 15.21 mmol of n-butyllithium was charged into the polymerization reactor as an n-hexane solution, and a polymerization reaction was started.

Copolymerization of 1,3-butadiene and styrene was carried out at a stirring speed of 130 rpm and a polymerization reactor internal temperature of 65° C. for 45 minutes while continuously supplying the monomers to the polymerization reactor. The amount of 1,3-butadiene supplied was 304 g, and the amount of styrene supplied was 96 g.

When 60 minutes had passed after the addition of n-butyllithium, the polymerization reactor was charged with a cyclohexane solution of 12.80 mmol (2.86 g) of 1-(4-N,N-dimethylaminophenyl)-1-phenylethylene, and the polymer solution was stirred at a stirring speed of 130 rpm.

When 65 minutes had passed after the addition of 1-(4-N,N-dimethylaminophenyl)-1-phenylethylene, a copolymerization reaction of 1,3-butadiene and styrene was carried out for 130 minutes while supplying monomers to the polymerization reactor. During polymerization, the stirring speed was 130 rpm and the polymerization reactor internal temperature was 65° C. The amount of 1,3-butadiene supplied was 608 g, and the amount of styrene supplied was 192 g. Of the entire amount of monomers charged and supplied to the polymerization reactor, the amount of 1-(4-N,N-dimethylaminophenyl)-1-phenylethylene charged was 0.14% by weight.

Subsequently, the polymer solution thus obtained was stirred at a stirring speed of 130 rpm, 12.8 mmol of N-(3-dimethylaminopropyl)trimethoxysilane was added to the polymer solution, and stirring was carried out for a further 15 minutes. Subsequently, 20 mL of a hexane solution containing 0.8 mL of methanol was added to the polymer solution, and the polymer solution was stirred for a further 5 minutes.

To the polymer solution were added 8.0 g of 2-tert-butyl-6-(3-tert-butyl-2-hydroxy-5-methylbenzyl)-4-methylphenyl acrylate (trade name: Sumilizer GM, manufactured by Sumitomo Chemical Co., Ltd.) and 4.0 g of pentaerythrityl tetrakis(3-laurylthiopropionate) (trade name: Sumilizer TP-D, manufactured by Sumitomo Chemical Co., Ltd.). Subsequently, the polymer solution was evaporated at normal temperature for 24 hours, and further dried under vacuum at 55° C. for 12 hours, thus giving a polymer.

The results of evaluation of the polymer are given in Table 1.

100 parts by weight of the polymer thus obtained, 78.4 parts by weight of silica (trade name: Ultrasil VN3-G, manufactured by Degussa, Inc.), 6.4 parts by weight of a silane coupling agent (trade name: Si69, manufactured by Degussa, Inc.), 6.4 parts by weight of carbon black (trade name: DIABLACK N339, manufactured by Mitsubishi Chemical Corp.), 47.6 parts by weight of an extender oil (trade name: JOMO PROCESS NC-140, manufactured by Japan Energy Corp.), 1.5 parts by weight of an antioxidant (trade name: Antigene 3C, manufactured by Sumitomo Chemical Co., Ltd.), 2 parts by weight of stearic acid, 2 parts by weight of zinc oxide, 1 part by weight of a vulcanization accelerator (trade name: Soxinol CZ, manufactured by Sumitomo Chemical Co., Ltd.), 1 part by weight of a vulcanization accelerator (trade name: Soxinol D, manufactured by Sumitomo Chemical Co., Ltd.), 1.5 parts by weight of a wax (trade name: Sunnoc N, manufactured by Ouchi Shinko Chemical Industrial Co., Ltd.), and 1.4 parts by weight of sulfur were kneaded by means of a Labo PlastOmill to prepare a polymer composition. The polymer composition thus obtained was molded into a sheet using a 6 inch roll, and the sheet was vulcanized by heating at 160° C. for 45 minutes, thus giving a vulcanized sheet. The results of evaluation of the physical properties of the vulcanized sheet are given in Table 1.

### Comparative Example 1

A 5 liter capacity stainless polymerization reactor equipped with a stirrer was washed, dried, and flushed with dry nitrogen. Subsequently, the polymerization reactor was charged with 2.55 kg of industrial hexane (density 680 kg/m3), 137 g of 1,3-butadiene, 43 g of styrene, 1.51 mL of tetrahydrofuran, and 1.09 mL of ethylene glycol diethyl ether. Subsequently, 3.54 mmol of n-butyllithium was charged into the polymerization reactor as an n-hexane solution, and a polymerization reaction was started.

Copolymerization of 1,3-butadiene and styrene was carried out at a stirring speed of 130 rpm and a polymerization reactor internal temperature of 65° C. for 2 hours while continuously supplying the monomers to the polymerization reactor. The amount of 1,3-butadiene supplied was 205 g, and the amount of styrene supplied was 65 g.

Subsequently, the polymer solution thus obtained was stirred at a stirring speed of 130 rpm, a cyclohexane solution of 2.88 mmol (0.64 g) of 1-(4-N,N-dimethylaminophenyl)-1-phenylethylene was charged into the polymer solution, and stirring was carried out for a further 90 minutes. 10 mL of a hexane solution containing 0.2 mL of methanol was added to the polymer solution, and the polymer solution was stirred for a further 5 minutes.

Of the entire amount of monomers charged and supplied to the polymerization reactor, the amount of 1-(4-N,N-dimethylaminophenyl)-1-phenylethylene charged was 0.14% by weight.

To the polymer solution were added 1.8 g of 2-tert-butyl-6-(3-tert-butyl-2-hydroxy-5-methylbenzyl)-4-methylphenyl acrylate (trade name: Sumilizer GM, manufactured by Sumitomo Chemical Co., Ltd.) and 0.9 g of pentaerythrityl tetrakis(3-laurylthiopropionate) (trade name: Sumilizer TP-D, manufactured by Sumitomo Chemical Co., Ltd.). Subsequently, the polymer solution was evaporated at normal temperature for 24 hours, and further dried under vacuum at 55° C. for 12 hours, thus giving a polymer. The results of evaluation of the polymer are given in Table 1.

100 parts by weight of the polymer thus obtained, 78.4 parts by weight of silica (trade name: Ultrasil VN3-G, manufactured by Degussa, Inc.), 6.4 parts by weight of a silane coupling agent (trade name: Si69, manufactured by Degussa, Inc.), 6.4 parts by weight of carbon black (trade name: DIABLACK N339, manufactured by Mitsubishi Chemical Corp.), 47.6 parts by weight of an extender oil (trade name: JOMO PROCESS NC-140, manufactured by Japan Energy Corp.), 1.5 parts by weight of an antioxidant (trade name: Antigene 3C, manufactured by Sumitomo Chemical Co., Ltd.), 2 parts by weight of stearic acid, 2 parts by weight of zinc oxide, 1 part by weight of a vulcanization accelerator (trade name: Soxinol CZ, manufactured by Sumitomo Chemical Co., Ltd.), 1 part by weight of a vulcanization accelerator (trade name: Soxinol D, manufactured by Sumitomo Chemical Co., Ltd.), 1.5 parts by weight of a wax (trade name: Sunnoc N, manufactured by Ouchi Shinko Chemical Industrial Co., Ltd.), and 1.4 parts by weight of sulfur were kneaded by means of a Labo Plastomill to prepare a polymer composition. The polymer composition thus obtained was molded into a sheet using a 6 inch roll, and the sheet was vulcanized by heating at 160° C. for 45 minutes, thus giving a vulcanized sheet. The results of evaluation of the physical properties of the vulcanized sheet are given in Table 1.

### Comparative Example 2

A 20 liter capacity stainless polymerization reactor equipped with a stirrer was washed, dried, and flushed with dry nitrogen. Subsequently, the polymerization reactor was charged with 10.2 kg of industrial hexane (density 680 kg/m3), 608 g of 1,3-butadiene, 192 g of styrene, 6.1 mL of tetrahydrofuran, and 4.7 mL of ethylene glycol diethyl ether. Subsequently, 15.38 mmol of n-butyllithium was charged into the polymerization reactor as an n-hexane solution, and a polymerization reaction was started.

Copolymerization of 1,3-butadiene and styrene was carried out at a stirring speed of 130 rpm and a polymerization reactor internal temperature of 65° C. for 3 hours while continuously supplying the monomers to the polymerization reactor. The amount of 1,3-butadiene supplied was 912 g, and the amount of styrene supplied was 288 g.

Following this, the polymer solution thus obtained was stirred at a stirring speed of 130 rpm, 12.80 mmol of N-(3-diethylaminopropyl)trimethoxysilane was added thereto, and stirring was carried out for 15 minutes. 20 mL of a hexane solution containing 0.8 mL of methanol was added to the polymer solution, and the polymer solution was stirred for a further 5 minutes.

To the polymer solution were added 8.0 g of 2-tert-butyl-6-(3-tert-butyl-2-hydroxy-5-methylbenzyl)-4-methylphenyl acrylate (trade name: Sumilizer GM, manufactured by Sumitomo Chemical Co., Ltd.) and 4.0 g of pentaerythrityl tetrakis(3-laurylthiopropionate) (trade name: Sumilizer TP-D, manufactured by Sumitomo Chemical Co., Ltd.). Subsequently, the polymer solution was evaporated at normal temperature for 24 hours, and further dried under vacuum at 55° C. for 12 hours, thus giving a polymer. The results of evaluation of the polymer are given in Table 1.

100 parts by weight of the polymer thus obtained, 78.4 parts by weight of silica (trade name: Ultrasil VN3-G, manufactured by Degussa, Inc.), 6.4 parts by weight of a silane coupling agent (trade name: Si69, manufactured by Degussa, Inc.), 6.4 parts by weight of carbon black (trade name: DIABLACK N339, manufactured by Mitsubishi Chemical Corp.), 47.6 parts by weight of an extender oil (trade name: JOMO PROCESS NC-140, manufactured by Japan Energy Corp.), 1.5 parts by weight of an antioxidant (trade name: Antigene 3C, manufactured by Sumitomo Chemical Co., Ltd.), 2 parts by weight of stearic acid, 2 parts by weight of zinc oxide, 1 part by weight of a vulcanization accelerator (trade name: Soxinol CZ, manufactured by Sumitomo Chemical Co., Ltd.), 1 part by weight of a vulcanization accelerator (trade name: Soxinol D, manufactured by Sumitomo Chemical Co., Ltd.), 1.5 parts by weight of a wax (trade name: Sunnoc N, manufactured by Ouchi Shinko Chemical Industrial Co., Ltd.), and 1.4 parts by weight of sulfur were kneaded by means of a Labo Plastomill to prepare a polymer composition. The polymer composition thus obtained was molded into a sheet using a 6 inch roll, and the sheet was vulcanized by heating at 160° C. for 45 minutes, thus giving a vulcanized sheet. The results of evaluation of the physical properties of the vulcanized sheet are given in Table 1.

TABLE 1

| | | | Comparative | Comparative |
|---|---|---|---|---|
| | | Example 1 | Example 1 | Example 2 |
| Mooney viscosity | — | 48.2 | 33.4 | 49.4 |
| Vinyl bond content | % by mole | 57.0 | 58.0 | 57.6 |
| Styrene unit content | % by | 24.8 | 23.7 | 24.8 |
| | weight | | | |
| Molecular weight | — | 1.21 | 1.06 | 1.17 |
| distribution | | | | |
| Abrasion resistance | mg | 240 | 390 | 350 |
| Fuel economy | — | 0.149 | 0.214 | 0.135 |
| tan δ (70° C.) | | | | |

1. A conjugated diene polymer comprising a conjugated diene-based monomer unit and a monomer unit based on a monomer represented by Formula (1) below, the polymer having at least one terminus modified by a compound represented by Formula (2) below 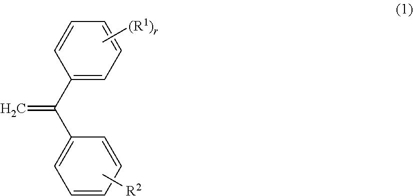
wherein r is 0 or 1, R¹ denotes a group containing at least one atom selected from the atomic group consisting of a nitrogen atom, an oxygen atom, and a sulfur atom, or a hydrocarbyl group having 1 to 10 carbon atoms and R² denotes a group containing at least one atom selected from the atomic group consisting of a nitrogen atom, an oxygen atom, and a sulfur atom 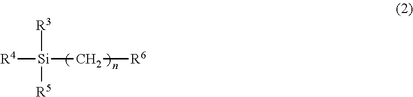
wherein n denotes an integer of 1 to 10, R³, R⁴, and R⁵ independently denote a hydrocarbyl group having 1 to 10 carbon atoms or a hydrocarbyloxy group having 1 to 10 carbon atoms, at least one of R³, R⁴, and R⁵ is a hydrocarbyloxy group, and R⁶ denotes a group containing at least one atom selected from the atomic group consisting of a nitrogen atom, an oxygen atom, and a sulfur atom.

2. The polymer according to claim 1, wherein the polymer comprises a monomer unit based a monomer represented by Formula (1) between a conjugated diene-based monomer unit-containing partial polymer chain and another conjugated diene-based monomer unit-containing partial polymer chain.

3. The polymer according to claim 1, wherein R¹ and R² of Formula (1) independently denote a group represented by Formula (3) below, a hydrocarbyl group, or a hydrogen atom, and at least one of R¹ and R² is a group represented by Formula (3) below 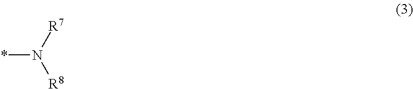
wherein R⁷ and R⁸ independently denote a hydrocarbyl group or a trihydrocarbylsilyl group, or R⁷ and R⁸ are bonded to each other and denote a hydrocarbylene group that may contain a nitrogen atom and/or an oxygen atom as a heteroatom and * denotes a bonding position.

4. The polymer according to claim 1, wherein in Formula (2) R⁶ is an optionally substituted amino group.

5. The polymer according to claim 1, wherein the vinyl bond content of the conjugated diene polymer, with the content of the conjugated diene-based monomer unit as 100% by mol, is not less than 20% by mol and not more than 70% by mol.

6. A conjugated diene polymer composition comprising the conjugated diene polymer according to claim 1 and a reinforcing agent.

7. The composition according to claim 6, wherein the reinforcing agent has a content of from 10 to 150 parts by weight per 100 parts by weight of the conjugated diene polymer.

8. A method for producing a conjugated diene polymer, comprising the steps of:
(A) polymerizing monomer components comprising a conjugated diene and a compound represented by Formula (1) below in a hydrocarbon solvent by an alkali metal catalyst, thus giving a polymer having an alkali metal catalyst-derived alkali metal in at least one terminus of a polymer chain; and
(B) reacting the polymer obtained in step A and a compound represented by Formula (2) below 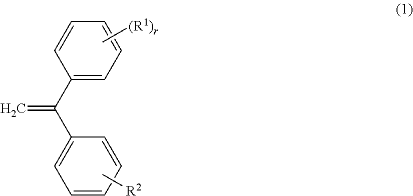
wherein r is 0 or 1, R¹ denotes a hydrocarbyl group or a group containing at least one atom selected from the atomic group consisting of a nitrogen atom, an oxygen atom, and a sulfur atom, and R² denotes a group containing at least one atom selected from the atomic group consisting of a nitrogen atom, an oxygen atom, and a sulfur atom 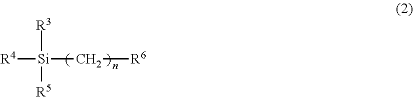
wherein n denotes an integer of 1 to 10, R³, R⁴, and R⁵ independently denote a hydrocarbyl group having 1 to 10 carbon atoms or a hydrocarbyloxy group having 1 to 10 carbon atoms, at least one of R³, R⁴, and R⁵ is a hydrocarbyloxy group, and R⁶ denotes a group containing at least one atom selected from the atomic group consisting of a nitrogen atom, an oxygen atom, and a sulfur atom.

9. The method according to claim 8, wherein R¹ and R² of Formula (1) independently denote a group represented by Formula (3) below, a hydrocarbyl group, or a hydrogen atom, and at least one of R¹ and R² is a group represented by Formula (3) below 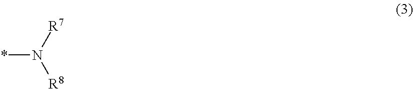
wherein R⁷ and R⁸ independently denote a hydrocarbyl group or a trihydrocarbylsilyl group, or R⁷ and R⁸ are bonded to each other and denote a hydrocarbylene group that may contain a nitrogen atom and/or an oxygen atom as a heteroatom and * denotes a bonding position.

10. The method according to claim 8, wherein in Formula (2) R⁶ is an optionally substituted amino group.
